(19) United States
(12) Patent Application Publication
(10) Pub. No.: US 2018/0287233 A1
(43) Pub. Date: Oct. 4, 2018

(54) Silenced Utility Scale Electrical Storage Device

(71) Applicant: Renewable Energy Systems Americas Inc., Broomfield, CO (US)

(72) Inventors: Jeremy Bass, Glasgow (GB); Andrew G. Oliver, Longmont, CO (US); Michael Anderson, 21 Greenway (GB); Alexander Bamberger, Boulder, CO (US)

(21) Appl. No.: 15/472,016

(22) Filed: Mar. 28, 2017

(51) Int. Cl. H01M 10/6563; H01M 2/10; H01M 10/613; H01M 10/627; G10K 11/178; G10K 11/168

(52) U.S. Cl. CPC H01M 10/6563; H01M 2/1077; H01M 10/613; H01M 10/627; G10K 2210/106; G10K 11/168; H01M 2220/10; G10K 2210/511; G10K 11/1788

(57) ABSTRACT

An electrical storage unit may include a container, one or more power cells disposed within the container, a cooling mechanism disposed within the container, and a noise reduction system disposed within container. In some instances, the electrical storage unit includes active components, passive components, or both.

### BACKGROUND

Renewable energy, such as wind and solar, are used to harvest energy from the ambient environment. Wind energy and solar energy vary throughout any given time period and, because the demand for energy also varies throughout these periods, the amount of energy harvested and the downstream demand for the energy may not match up. Thus, an amount of the harvested energy is often stored in batteries in an energy storage unit. These energy storage units may store energy in times of surplus and make energy available to the grid in times of deficit.

An energy station disclosed in the prior art is described in WIPO Patent Application No. WO2014087124 issued to Daniel R. Simon, et al. This reference discloses a system comprising a plurality of battery assemblies. Each battery assembly comprises energy storage that can be charged and control electronics and communication means. Each battery assembly is configured to act as a local hub for local DC power demand monitoring; and a local DC power supply for DC loads. A method is provided for installing the system by co-locating a battery assembly near an energy meter and consumer unit and connecting the battery assembly to re-use existing lighting circuit wiring. A battery assembly for use in a distributed battery system of further battery assemblies is also provided. The battery system can receive electrical energy from a power source and comprises electrical energy storage, power electronics, control electronics and communication means. The control and communication means is configured to receive data and charge or discharge the electrical energy storage. This reference also teaches that harmonic noise is reduced by negating the need for numerous power conversion and power adaptors throughout the system. Other energy storage system is disclosed in U. S. Patent Publication Nos. 2007/0276547 issued to Craig Howard Miller and 2016/0241042 issued to Andrea A. Mammoli. These references are herein incorporated by reference for all that they disclose.

### SUMMARY

In one embodiment, an electrical storage unit includes a container, one or more power cells disposed within the container, a cooling mechanism disposed within the container, and a noise reduction system disposed within container.

The noise reduction system may include an active cancellation mechanism.

The cooling mechanism may include at least one fan blade.

The noise reduction system may include at least one microphone that records sounds from the cooling mechanism.

The noise reduction system may include at least one speaker that emits an inverted sound of the recorded sound.

The noise reduction system may include a passive reduction mechanism.

The container may include an inside surface, and the passive reduction mechanism may include an acoustic absorbent material that lines the inside surface.

The acoustic absorbent material may be an absorptive mineral wool.

The acoustic absorbent material may include a foamed material.

The acoustic absorbent material may include a layered material wherein at least one layer of the layered material is lead.

The container may be a modified shipping container.

The modified shipping container may include an air intake and an air outlet as part of the cooling system.

The noise reduction system may include a passive cancellation mechanism and an active cancellation mechanism.

The active cancellation mechanism may cancel tonal sounds and the passive reduction mechanism reduces a volume of broadband sounds.

In one embodiment, the electrical storage unit may include a modified shipping container. The modified shipping container may include an inside surface, an acoustic absorbent material lining the inside surface, a plurality of power cells disposed within the container, on or more fans disposed within the container, and an active cancellation mechanism disposed within container to at least reduce a volume of a tonal sound produced by the fans.

The active cancellation mechanism may include at least one microphone that records the tonal sound of the fan and at least one speaker that emits an inverted tonal sound of the recorded sound.

The acoustic absorbent material may be an absorptive mineral wool.

The acoustic absorbent material may include a foamed material.

The acoustic absorbent material may include a layered material wherein at least one layer of the layered material is lead.

In one embodiment, a storage unit may include a container, an electrical energy storage means disposed within the container, a cooling means disposed within the container to cool the electrical power means, a passive noise reduction means disposed within the container to passively reduce a volume of a sound emanating from the container including a tonal sound of the cooling means, and an active cancellation means disposed within container to at least reduce the tonal sound produced by the cooling means.

Any of the aspects of the principles detailed above may be combined with any of the other aspects detailed herein.

### BRIEF DESCRIPTION OF THE DRAWINGS

The accompanying drawings illustrate various embodiments of the present apparatus and are a part of the specification. The illustrated embodiments are merely examples of the present apparatus and do not limit the scope thereof.

FIG. 1 illustrates a perspective view of an example of an electrical storage device in a container stack in accordance with the present disclosure.

FIG. 2 illustrates a perspective view of an example of a cooling mechanism in accordance with the present disclosure.

FIG. 3 illustrates a perspective view of an example of a passive noise reduction system in accordance with the present disclosure.

FIG. 4 illustrates a perspective view of an example of a passive noise reduction system in accordance with the present disclosure.

FIG. 5 illustrates a block diagram of an example of an active noise reduction system in accordance with the present disclosure.

FIG. 6 is a graphical representation of a waveform of sound, in accordance with the present disclosure.

FIG. 7 is a graphical representation of an example of an anti-phase waveform of the waveform depicted in FIG. 6. in accordance with the present disclosure.

Throughout the drawings, identical reference numbers designate similar, but not necessarily identical, elements.

### DETAILED DESCRIPTION

The principles disclosed herein include an utility scale electrical storage device which has advanced sound reduction measures to minimize sound emission. The storage device includes a number of battery cells, inverters, and electrical control equipment. In some embodiments, these components are housed in a modified shipping container. In alternative embodiments, these components are housed in other appropriate types of containers, or may be individual components not contained in a single container. For example, the present exemplary systems and methods may be incorporated into different structures and systems, many of which are not utility scale, including, but in no way limited to, battery buildings, pre-fabricated battery containers, individual power conversion systems (inverter) units, HVAC systems, home energy storage units, and the like.

In some instances, the container is lined with an acoustic absorbent material that passively provides a reduction in broadband sound emission from the container. As the aforementioned components heat up during operation, a cooling mechanism incorporated into the container may force ventilate the container. In some instances, force ventilation is accomplished with cooling fans or another appropriate type of cooling mechanism. Noise generated with the use of the cooling mechanism may be reduced with an active noise reduction mechanism. In some cases, the active cancellation mechanism includes a built-in active noise control that cancels sound emission at the source.

In some instances, the electrical storage unit has a storage capacity around two megawatt hours and may be power rated to four megawatts. In some applications, such as for a wind farm or a solar farm, multiple electrical storage units may be used. Other applications that may include these types of electrical storage units include tidal harvesting applications, power relay stations, off-grid power stations, other alternative energy applications, or combinations thereof.

The electrical storage units may include utility scale battery storage units, active noise cancellation techniques, and passive noise reduction techniques to produce a quieter storage device. As storage devices are often deployed in urban areas close to residential areas, the social and economic benefits of a noise reduced device, in terms of community acceptance, may be considerable.

The storage device may be connected to the grid. These storage device may include a number of battery cells, a power conversion system (which includes inverters), and electrical control equipment. In one example, these components are housed in a modified shipping container. The container can be force ventilated using cooling fans to control the internal temperature.

The device may provide electrical services to the operator of an electricity network (e.g. frequency response, upgrade deferral etc.) or to provide revenue for the owner, (e.g. through energy arbitrage). The storage unit may achieve these goals by receiving electrical energy from the electrical grid system and storing the electricity within its battery cells when the electricity price is generally low. The storage units may discharge the electricity to the electrical grid system during periods that are appropriate, such as when demand is high, the price is acceptable, when needed to meet obligations, or when otherwise deemed appropriate.

In some cases, the storage devices may provide multiple services in parallel. The storage devices may balance demand of each of these services to ensure that maximum value is delivered to the stakeholders.

In some cases, programmed instructions stored in memory and operating the electrical storage units may cause a processor to store energy during periods of low price and provide energy in periods where, as a result of either high demand or low generation, the system electrical frequency is beginning to drop below a designated value, such as 60 Hz. The programmed instructions may also cause the electrical storage units to distribute power as deemed appropriate where, for example, the demand on a part of an electrical grid has been growing over time and has increased to the point where it occasionally exceeds the capacity of the grid to supply it. A storage device may be used to meet the occasional exceedances and so delay the necessity of upgrading that part of the grid infrastructure. The programmed instructions may cause the storage units to store energy during periods of low price and provide energy in periods of high price, so that a revenue is generated from the price differential. Other services that the programmed instructions may provide include, but are not limited to, renewable energy integration, micro-grids, load shifting, backup power, and grid support services.

In some cases, passive sound control techniques include an acoustically absorptive material that reduces reflected/transmitted sound. These materials may line interior surfaces of the container, such as the container wall or the surfaces of the components within the container. For example, panels of acoustically absorbing material may be installed adjacent to an inside surface of the container's walls. In some instances, this acoustically absorbing material might be an absorptive mineral wool or a combination of layers that include mineral wool and lead.

Active noise control mechanisms may involve actively cancelling an unwanted sound within the space defined by the container. This may reduce the noise radiated to the environment surrounding the electrical storage device. In some cases, the active cancellation mechanism is frequency dependent and may be tuned to provide specific benefits at specific sound frequencies. Targeting specific sound frequencies may be useful if the noise source has a tonal characteristic, which is often the case with cooling fans. Targeting specific sound frequencies may result in a lower overall sound power level having less tonal sound character than would otherwise be the case. This may be significant because the potential for disturbance of a given level of sound is greater for a sound with a distinguishable character, such as a tone, than it is for featureless sound.

To avoid the potential for cooling fans or other cooling mechanism to radiate tonal sound to the environment, an active cancellation system may be used to cancel the emission of that tone, as well as a general reduction in sound power levels over a wider range of frequencies.

The active noise control may involve one or more microphones that are placed within the space defined by the container. The evolution of the sound pressure level can be captured over a relatively short time period. Signal processing techniques are then used to determine the phase and amplitude of the captured signal, and a new signal is created that has the same amplitude as the record sound, but the opposite phase (i.e. so that it is completely out of phase with the original signal). The newly created signal is broadcast over one or more speakers within the container's space and destructively interferes with the original, unwanted signal in such a way as to cancel it out. In some implementations, this process may significantly reduce the sound power level of the original signal.

In terms of passive noise control, the shipping container may be lined with acoustically absorptive material to reduce broadband sound radiation to the environment. At least some of the pipes feeding the cooling fans may be acoustically lagged and mechanically isolated to prevent vibrating elements from transmitting vibration to the fabric of the container. In terms of active noise control, the cooling fans may have an active cancellation mechanism built into them, so that they produce low levels of noise devoid of tonal noise at the blade passing, or any other, frequency.

There may be several benefits of the principles described herein. For example, the device may emit lower noise emission than comparable, unsilenced systems thereby reducing the likelihood of residential disturbance and improving community acceptance. In another example, deployment of silenced storage units in areas that are zoned with noise emission restrictions may result in more storage capacity than would be otherwise deployable. This may be particularly beneficial in urban areas.

Another benefit may result in the storage units containing less or no tonal component and may predominately emit just a broadband noise. Broadband noise is more benign than other types of noises, because broadband noise is more bland and has no distinguishable character. As a result, broadband noise may be less likely to disturb nearby residents and may be more easily masked by other sources of environmental and urban noise. Also, where conventional storage units might involve the construction of an acoustic barrier, or earth bund, around an installation of the electrical storage unit to reduce noise emission levels, the installation of these silent storage units may result in avoiding a need for these additional expensive provisions.

For the purposes of this disclosure, the term “aligned” means parallel, substantially parallel, or forming an angle of less than 35 degrees. Also, for the purposes of this disclosure, the term “transverse” means perpendicular, substantially perpendicular, or forming an angle between 55 and 125 degrees. Further, for the purposes of this disclosure, the term “length” refers to the longest dimension of an object.

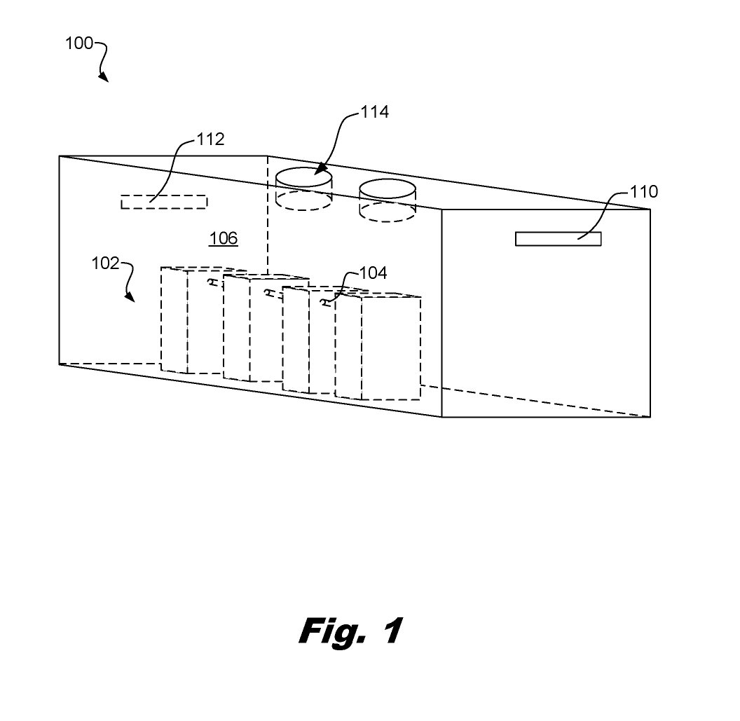

With respect to the figures, FIG. 1 depicts an example of a container 100. In this example, the container 100 may be a modified shipping container. Shipping containers are used to transport commercial goods and raw materials locally and all over the world. The containers are transported by land and sea vehicles. Shipping containers are stored in shipping yards or other locations when the containers are emptied, loaded, or stored in an empty or loaded state en route to or from their goods' destination. Shipping containers are attached to transport vehicles and lifted by many different types of cranes during their many journeys via the corner casting mold (ISO 1161) that are attached to the shipping container's corners.

Disposed within the container 100 illustrated in FIG. 1 are multiple battery units 102, which can receive electrical power from an alternative power source, the grid, another source, or combinations thereof. Pipes 104 or conduits that carry cables, fluids, water, gas, other components, or combinations thereof and may connect the battery units 102.

The battery units 102 may be prone to heating, and a cooling mechanism may be implemented to reduce the temperature of the battery units 102 or within the space 106 defined by the container 100. In this example, the cooling mechanism includes a rotary fan 108. An air intake 110 and an air outlet 112 may be incorporated into the container 100 to enhance air flow. Rotation of the fan blades 114 may result in unwanted noise.

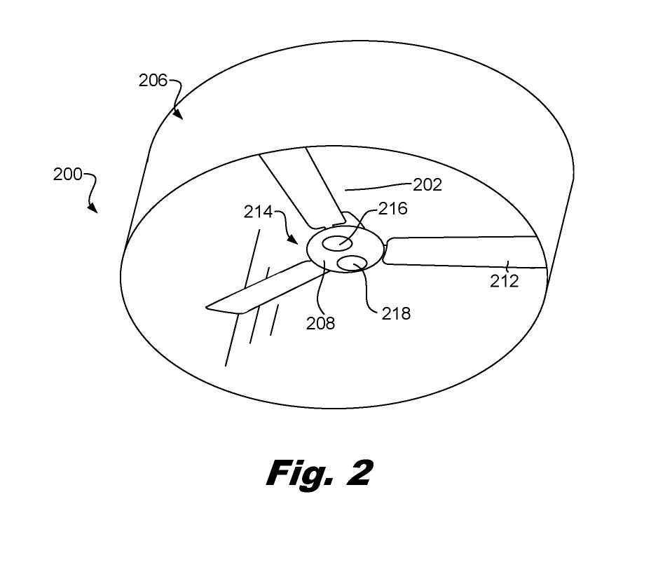

FIG. 2 depicts an example of a fan assembly 200. In this example, the fan assembly 200 includes a fan body 208 disposed within a bore defined by a fan shroud 206. A plurality of fan blades 212 may be connected to the fan body 208. The fan body 208 can rotate about a rotational axis which cause the fan blades 114 to rotate.

For purposes of this disclosure, a fan is a machine used to create flow within a fluid, such as air. The fan may include a rotating arrangement of vanes or blades which act on the air to direct the airflow or be bladeless. In some examples, the fan assemblies are powered by electric motors, but other sources of power may be used such as hydraulic mechanism, pneumatic mechanism, motors, other types of mechanism, or combinations thereof. The fan assemblies may generate noise from the rapid flow of air around blades and sometimes from the motor.

An active noise cancellation mechanism 214 may be incorporated into a portion of the fan assembly 200. The active noise cancellation mechanism 214 may include one or more microphones 216 and one or more speakers 218.

Any of the noises from the electrical storage unit, collectively or in isolation, may have undesirable effects on the user or others located nearby. The noise from the electrical storage unit may be reduced and/or canceled with a noise control system incorporated into the electrical storage unit or integrated into multiple electrical storage units. This noise control system may include at least one microphone, processing resources, and at least one speaker. The microphone may detect the noise emanating from various sources within the container, such as the cooling mechanism, a fan assembly, fluid traveling through a pipe, another source, or combinations thereof. This microphone may be incorporated into the container, the cooling mechanism, the fan assembly, a pipe, a noise source, another component within the container, or combinations thereof.

The microphone may be a dynamic microphone with a lightweight diaphragm attached to a coil of wire suspended in a permanent magnetic field. In this type of example, the diaphragm can be moved by the alternating pressures of the noise emanating from the cooling mechanism. Movement of the diaphragm, in turn, may move the wire. As the wire moves within the magnetic field, an electrical current is produced that represents the characteristics of the original noise. In some situations, this dynamic microphone has an amplifier to boost the electrical signal representing the noise's characteristics.

In other examples, a capacitive microphone is used to detect the original noise. This microphone may incorporate an electrical circuit with two parallel plates, one that moves in response to the noise's pressure waves and another plate that remains stationary. An electrical field is present between the parallel plates. As the noise's pressure waves moves the first plate, the distance between the first and second plates changes. As the distance of the plates change back and forth based on the alternating pressures of the original noise, the capacitance of the circuit also fluctuates, which produces a detectable alternating electrical current. As a result, an electrical signal is produced that represents the characteristics of the original noise.

In some examples, the microphone picks up sounds equally from all angles. In one type of example, the microphone can pick up the sounds from each of the various components of the container that make noise during their operation. In other examples, the microphone is focused towards picking up sounds from specific angles or from specific objects, such as a fan assembly or another type of cooling mechanism. While the examples above have been described with reference to specific types of microphones and specific features of the microphones, any appropriate type of microphone or any appropriate microphone feature may be incorporated into the principles described in the present disclosure.

The microphone may send the signals representing the detected noise to the processing resources. In some examples, the microphone sends the signals in an analog format. But, in other examples, the microphone sends the signals in a digital format. In this type of example, an analog/digital converter may be used to generate the digital signal. The processing resources can receive the signals and determine the noise's waveform characteristics. In some examples, the signal represents a number of sounds from different sources. Each these sources may produce sounds with different waveform characteristics. The processing resources may have the capability of detecting each type of sound represented in the signal.

Based on the analysis of the sound's waveform or waveforms, the processing resources can cause an anti-phase waveform to be determined. This anti-phase waveform may be opposite of the original sound's waveform. In other words, the anti-phase waveform may be 180 degrees out of phase with the waveform determined by the processing resources. In other examples, this anti-phase waveform has at least some characteristics that are offset from the characteristics of the detected sound. In those examples where multiple sounds are detected, the processing resources create an anti-phase waveform that takes the different sound sources into consideration.

The determined anti-phase waveform may be stored locally in a buffer or another type of memory. The determined anti-phase waveform may be directed to the speaker to be emitted into the environment surrounding the cooling mechanism or other noise source in the container.

The determined anti-phase waveform exhibits the characteristics of at least reducing the volume of the sounds emanating from the cooling mechanism or other noise source in the container. In some examples, the determined anti-phase waveform cancels the sounds emanating from the cooling mechanism. In either situation, the noise emanating from the cooling mechanism or other noise source appears to the user to be reduced and/or eliminated.

Sounds traveling through the air exhibit alternating pressure levels. When the sounds from the cooling mechanism exhibit a high pressure, the sounds from the speakers (the anti-phase waveforms) may exhibit a corresponding low pressure. Similarly, when the sounds from the cooling mechanism exhibit a low pressure, the sounds from the speakers (the anti-wave forms) may exhibit a corresponding high pressure. As a result, the pressure variations are reduced or eliminated, cancelling the noise. In some examples, the anti-phase waveform's pressure cycle's may not be perfectly out of phase with the original waveform. But, in these types of examples, the noise from the cooling mechanism or other noise source in the container may be at least reduced, if not eliminated.

In some cases, the noise control system initially detects the sounds, records the sounds, and produces the anti-phase waveform without continuously monitoring for changes in the noises from the cooling mechanism or other noise source in the container. In this type of situation, the noises may be consistent over time, and the anti-phase waveform may not need to be modified. But, in other cases, the microphone continuously monitors the sounds emanating from the noise of the cooling mechanism or other noise source through the microphone and sends signals to the processing resources. As the processing resources detect changes in the noise, the processing resources may cause the anti-phase waveform to change to reflect the changed sound waves. Thus, sounds of the anti-phase waveform are emitted into the environment surrounding the cooling mechanism that more effectively cancel and/or reduce the unwanted noise.

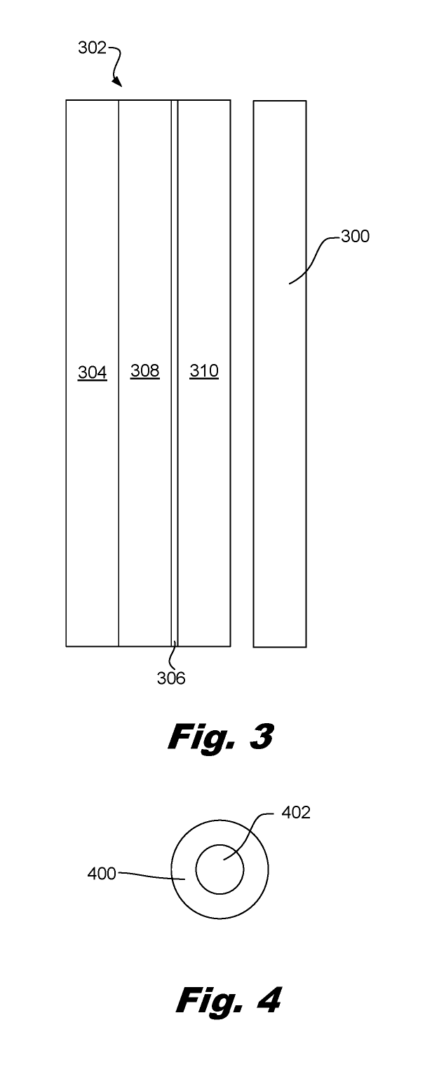

FIG. 3 depicts an example of a passive noise reduction system 302. In this example, the passive noise reduction system 302 may include noise absorbent material 300 that lines or is at least adjacent to an inside surface of the container. In this example, the noise absorbent material 300 is adjacent to the container wall 304.

Any appropriate material may be used as a noise absorbent material 302. In some examples, wool or mineral wool is used as a noise absorbent material 300. In other examples, a foamed material is used as an absorbent material. In additional examples, the absorbent material is included in a laminated structure. In the illustrated example, the passive noise reduction system includes a laminated structure that includes a lead layer 306 sandwiched between a first foamed layer 308 and a second foamed layer 310. One benefit provided by the passive noise reduction system is that sound frequency across a wide range are minimized, not just some specific tonal frequencies. Thus, those broadband sounds that may emanate from the container, if any, are reduced due to the passive noise reduction system 300.

For the purposes of this disclosure, “foam” generally refers to a substance that is formed by trapping pockets of gas in a liquid or solid. In this example, the first and second formed layers are solid layers that include pockets of gas, such as air, trapped within. The foamed materials reduce the weight of these layers and have an acoustical impedance mismatch with the lead layer that further inhibits that the propagation of sound through the container wall.

In some examples, lead is used as a sound insulator 306. The lead layer may include a 0.2 to 0.8 mm thick cross section of pure lead weighing in at 3 to 8 kg per square meter. Bonded to each side of the lead is a layer of dense foam or mineral wool forming the sandwich. In one example, a side of foamed layer includes an adhesive with a peel-off backing for attachment to the inside surface of the wall or other inside surface in the container. In one instance, the thickness of the laminated structure is approximately 10-20 mm thick.

FIG. 4 depicts an example of a passive noise reduction system 400 that is positioned around a pipe 402 or a duct. Material that absorbs noise may be wrapped around any appropriate surface within the container. While the examples above have been described as the cooling mechanism having a fan assembly, other types of cooling mechanisms may include pipes, ducts, or other components. In some cases these types of cooling mechanisms are used in combination with a fan assembly or in lieu of the fan assembly. The pipes or ducts in the container may be used to carry cool air, water, or another type of fluid to components within the container for cooling.

Noise radiating from piping and ductwork can be caused by water or other liquids passing through elbows, valves, nozzles, or other transition pieces. Duct noise is caused by air flowing past obstructions or branches which results in the vibration of the metal ductwork. For the purposes of this disclosure, a breakout noise generally refers to noise from pipes or ductwork that radiates radially out away from the pipe or duct. This noise may be caused by the pipe wall vibrating due to the internal fluid passage. The breakout noise may be controlled, reduced, or eliminated with the absorbent material disposed about the pipe or duct. In some examples, the acoustical absorbent material may be wrapped about the pipe or ductwork or at least portions thereof. In other examples, the pipe or other components may be insulated from vibration sources. For example, the pipe or ducts may have a foot joint or other type of joint that is made of neoprene or another type of material that insulates the component from absorbing and transferring vibrations.

In other examples, a microphone may be located adjacent to the elbows, valves, nozzles, or other transition pieces to detect the sounds for active cancellation. In other examples, the microphone(s) is (are) positioned within the space defined by the container and the microphone detects the breakout noise along with all the other sounds resonating within the container.

For the purposes of this disclosure, a stream noise generally refers to a noise carried along with the fluid as it flows down the pipe or duct. This noise is most apparent at the pipe's or duct's outlet. The stream noise may be controlled, reduced, and/or eliminated by placing a microphone adjacent to the outlet to detect the stream noise for active cancellation. In other examples, the microphone(s) is (are) positioned within the space defined by the container and the microphone detects the stream noise along with all the other sounds resonating within the container.

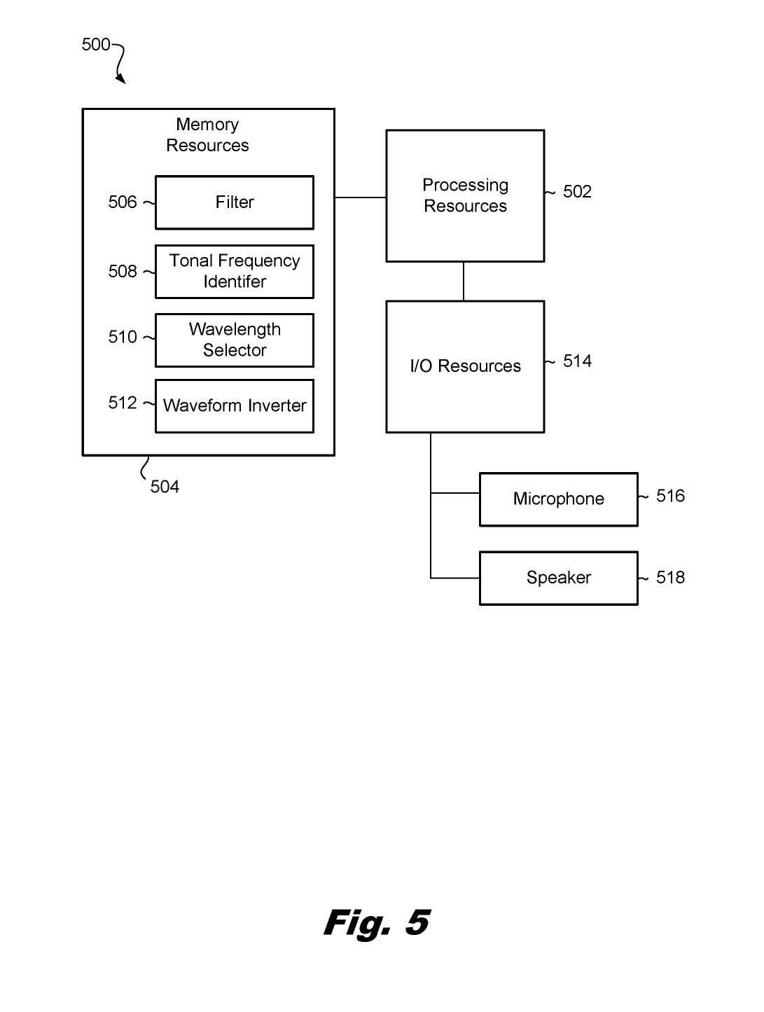

FIG. 5 illustrates a block diagram of an example of an active cancellation system 500 in accordance with the present disclosure. The active cancellation system 500 may include a combination of hardware and program instructions for executing the functions of the active cancellation system 500. In this example, the active cancellation system 500 includes processing resources 502 that are in communication with memory resources 504. Processing resources 502 include at least one processor and other resources used to process programmed instructions. The memory resources 504 represent generally any memory capable of storing data such as programmed instructions or data structures used by the active cancellation system 500. The programmed instructions stored in the memory resources 504 include a filter 506, a tonal frequency identifier 508, a wavelength selector 510, and a waveform inverter 512.

The memory resources 504 include a computer readable storage medium that contains computer readable program code to cause tasks to be executed by the processing resources 502. The computer readable storage medium may be a tangible and/or non-transitory storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, magnetic based memory, other types of memory, or combinations thereof.

The processing resources 502 may be in communication with input/output (I/O) resources 514. The I/O resources 514 may include any appropriate type of mechanism for communicating with remote devices. For example, the I/O resources 514 may include a transmitter, a wireless transmitter, a receiver, a transceiver, a port for receiving an external memory, a network interface, another I/O resource, or combinations thereof.

The I/O resources may be in communication with any appropriate device. In the illustrated example, the I/O resources 514 are in communication with a microphone 516 and a speaker 518, or combinations thereof. These remote devices may be located in the container, incorporated into the fan assembly, may be independent of the fan assembly, may be in communication with the I/O resources over a network, may be part of another device within the container, may be incorporated into a noise source within the container, or combinations thereof.

The filter 506 represents programmed instructions that, when executed, cause the processing resources 502 to remove a bandwidth of wavelengths from the sounds recorded by the microphone 516. In some cases, those wavelengths that are too high or low pitched to emanate from a fan assembly may be filtered out. In some examples, wavelengths that are likely to be at frequencies at which people speak or other desirable sounds may also be removed. Factors that the filter 506 may consider when determining which sounds to cancel and/or reduce include the consistency of the sound, the pitch of the sound, the loudness of the sound, other features of the sound, or combinations thereof. Often, the sounds emanating from the cooling mechanism or another noise source within the container, which it may be desirable to cancel or reduce, are consistent over time and exhibit long wavelength characteristics. On the other hand, sounds associated with talking, music, or entertainment, which may not be desirable to cancel or reduce, may include inconsistent sounds over time and often have a higher pitch. Thus, the filter may use policies that reflect these types of characteristics when determining which sounds to cancel and/or reduce. The filter 506 may reduce the range of frequencies that the tonal frequency identifier 508 has to analyze.

The tonal frequency identifier 508 represents programmed instructions that, when executed, cause the processing resources 502 to identify the frequencies that are recorded by the microphone 516. In some cases, the tonal frequencies belong to a range of wavelengths with a distinct pitch that is undesirable to the human ear.

The wavelength selector 510 represents programmed instructions that, when executed, cause the processing resources 502 to select a range of wavelengths that are to be canceled or at least reduced. This selection may be based on the analysis performed by the tonal frequency identifier 508 and may represent the sounds emanating from the cooling mechanism, fan assembly, other noise source, or combinations thereof.

The waveform inverter 512 represents programmed instructions that, when executed, cause the processing resources 502 to construct a cancelling or reducing sound that reflects a waveform representing the sounds selected by the wavelength selector 510, but are 180 degrees out of phase. In some cases, when the waveform representing sounds selected for cancellation or at least reduction exhibit a waveform crest and a waveform trough that alternatingly occur at consistent intervals. The cancelling or reducing sound's anti-phase waveform exhibits a trough equivalent in magnitude to the waveform's crest and vice versa at the consistent intervals to counter affect the original sound.

The inverted sound may be emitted through a speaker 518. The speaker 518 may be integrated into the cooling mechanism, fan assembly, the container, another component within the space defined by the container, or combinations thereof. As the sound represented by the anti-phase waveform is emitted into the container, the alternating air pressures caused by the cooling mechanism or other source are canceled or reduced by the opposing alternating air pressures induced by the sounds of the anti-phase waveform from the speaker. As a result, these unwanted sounds from are either canceled or reduced.

Further, the memory resources 504 may be part of an installation package. In response to installing the installation package, the programmed instructions of the memory resources 504 may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources 504 can include integrated memory such as a hard drive, a solid state hard drive, or the like.

In some examples, the processing resources 502 and the memory resources 504 are located within the container, the cooling mechanism, the fan assembly, another component within the container, or combinations thereof. The memory resources 504 may be part of main memory, caches, registers, non-volatile memory, or elsewhere in their memory hierarchy that are located in the container. Alternatively, the memory resources 504 may be in communication with the processing resources 502 over a network. For example, the memory resources 504 and processing resources 502 may be used to control the sound cancellation for multiple electrical storage units. Further, the data structures, such as the libraries, may be accessed from a remote location over a network connection while the programmed instructions are located locally. Thus, the active cancellation system 500 may be implemented within the container, cooling mechanism, fan assembly, other component in the container, or combinations thereof. Such an implementation may occur through input mechanisms, such as push buttons, touch screen buttons, voice commands, dials, levers, other types of input mechanisms, or combinations thereof.

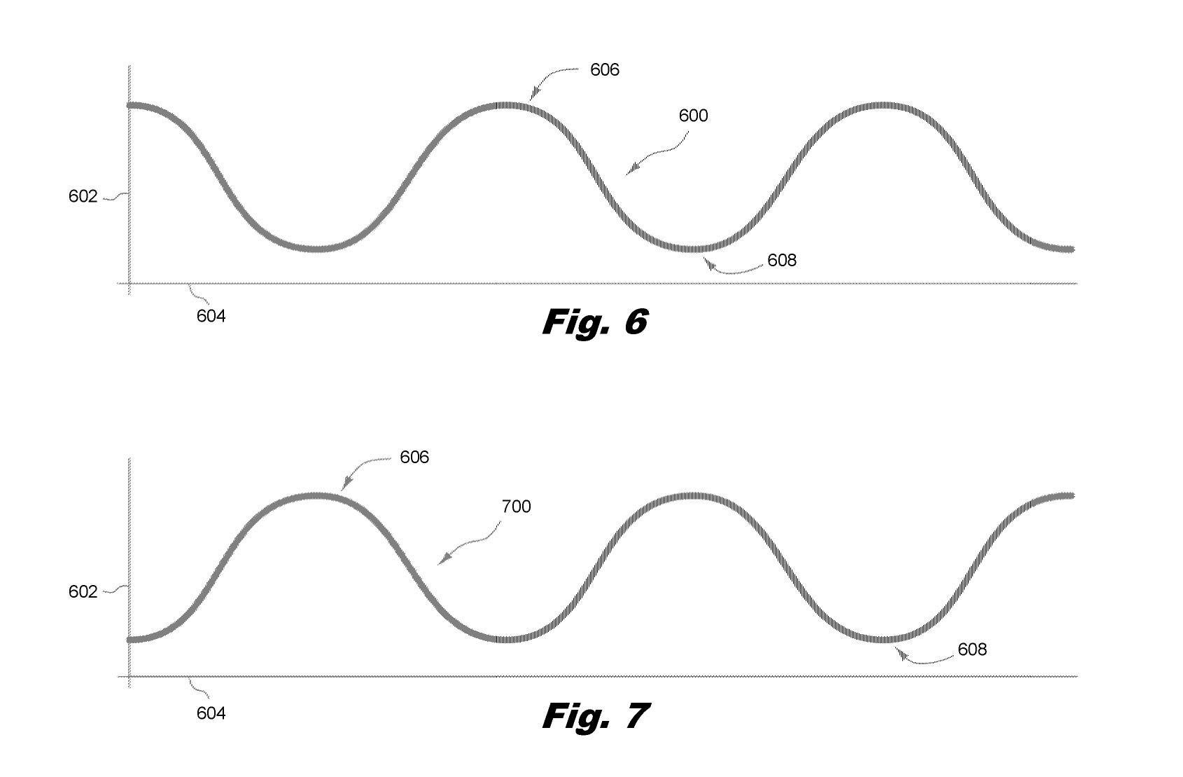

FIG. 6 depicts a representation of an example of a waveform 600 of sound. In this example, the vertical axis 602 represents a level of compression of air molecules while the horizontal axis 604 represents time. Accordingly, a crest 606 in the waveform 600 represents a higher compression while a trough 608 in the waveform 600 represents a lower compression. Thus, over time the sound alternatingly exhibit higher compression and lower compression of air molecules.

FIG. 7 depicts a representation of an example of an anti-phase waveform 700 of the waveform depicted in FIG. 6. In this example, the vertical axis 602 represents a level of compression of air molecules while the horizontal axis 604 represents time. Accordingly, a crest 606 in the waveform 600 represents a higher compression while a trough 608 in the waveform 600 represents a lower compression. The anti-phase waveform is 180 degrees off phase of the waveform 600 in the example of FIG. 6.

The operations presented in this document are not inherently related to any particular apparatus. Various general-purpose systems may also be used with programs in accordance with the teachings in this document, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described in this document.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and may be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrical storage unit, comprising:
at least one energy storage device;
a cooling mechanism configured to cool the energy storage device; and
a noise reduction system associated with the electrical storage unit.

2. The electrical storage unit of claim 1, wherein the noise reduction system comprises an active cancellation mechanism.

3. The electrical storage unit of claim 1, wherein the cooling mechanism comprises at least one fan blade.

4. The electrical storage unit of claim 1, wherein the cooling mechanism comprises at least one bladeless fan.

5. The electrical storage unit of claim 1, wherein the noise reduction system comprises at least one microphone that records sounds from the noise reduction system.

6. The electrical storage unit of claim 5, wherein the noise reduction system comprises at least one speaker that emits an inverted sound of the recorded sound.

7. The electrical storage unit of claim 1, wherein the noise reduction system comprises a passive reduction mechanism.

8. The electrical storage unit of claim 7, wherein the electrical storage unit further comprises a container having an inside surface; and
wherein the passive reduction mechanism comprises an acoustic absorbent material that lines the inside surface.

9. The electrical storage unit of claim 8, wherein the acoustic absorbent material comprises an absorptive mineral wool.

10. The electrical storage unit of claim 8, wherein the acoustic absorbent material comprises a foamed material.

11. The electrical storage unit of claim 8, wherein the acoustic absorbent material comprises a layered material wherein at least one layer of the layered material is lead.

12. The electrical storage unit of claim 1, wherein the electrical storage unit further comprises a container, wherein the container comprises a modified shipping container.

13. The electrical storage unit of claim 12, wherein the modified shipping container comprises an air intake and an air outlet.

14. The electrical storage unit of claim 1, wherein the noise reduction system comprises a passive reduction mechanism and an active cancellation mechanism.

15. The electrical storage unit of claim 14, wherein the active cancellation mechanism is configured to cancel tonal sounds and the passive reduction mechanism reduces a level of broadband sound.

16. An electrical storage unit, comprising:
a modified shipping container;
the modified shipping container including an inside surface;
an acoustic absorbent material lining the inside surface;
a plurality of power cells disposed within the modified shipping container;
a fan disposed within the modified shipping container; and
an active cancellation mechanism disposed within container to at least reduce a volume of a tonal sound produced by the fan.

17. The electrical storage unit of claim 16, wherein the active cancellation mechanism comprises:
at least one microphone that records the tonal sound of the fan;
at least one speaker that emits an inverted tonal sound of the recorded tonal sound.

18. The electrical storage unit of claim 16, wherein the acoustic absorbent material comprises an absorptive mineral wool, a foamed material, or combinations thereof.

19. The electrical storage unit of claim 16, wherein the acoustic absorbent material comprises a layered material wherein at least one layer of the layered material is lead.

20. A storage unit, comprising:
a container;
an electrical energy storage means disposed within the container;
a cooling means disposed within the container to cool the electrical energy storage means;
a passive noise cancellation means disposed within the container to passively reduce a volume of a sound emanating from the container including a tonal sound of the cooling means;
an active cancellation means disposed within the container to at least reduce the tonal sound produced by the cooling means.
